(19) United States
(12) Patent Application Publication
(10) Pub. No.: US 2015/0090670 A1
(43) Pub. Date: Apr. 2, 2015

(54) METHOD FOR TREATING WASTEWATER

(71) Applicant: ORIGINOIL, INC., Los Angeles, CA (US)

(72) Inventors: Nicholas Eckelberry, Los Angeles, CA (US); Andrew Davies, Los Angeles, CA (US)

(73) Assignee: ORIGINOIL, INC., Los Angeles, CA (US)

(21) Appl. No.: 14/566,819

(22) Filed: Dec. 11, 2014

Related U.S. Application Data
(63) Continuation-in-part of application No. 13/942,348, filed on Jul. 15, 2013.

(51) Int. Cl. C02F 1/76; C02F 1/00; C02F 1/40

(52) U.S. Cl. CPC C02F 1/76; C02F 1/40; C02F 1/004; C02F 2201/46145; C02F 2209/04
USPC 210/748.2; 210/192; 210/143

(57) ABSTRACT

A system for treating wastewater is disclosed that includes a series of interconnected reactor tubes. Each reactor tube comprises an outer cathode and an inner anode. The inner anode is positioned within the outer cathode. A voltage differential is applied across the inner anodes and the outer cathodes as wastewater flows between the inner anodes and outer cathodes. As the wastewater flows through the reactor tubes, chlorine based elements are generated to treat the wastewater. The system can include an injector to add chloride salts into the wastewater to generate chlorine based elements. The system can also include a feedback path to divert a portion of the wastewater with chlorine based elements back to the influent wastewater so that the chlorine based elements are mixed with the influent wastewater. The inner anode and the outer cathode can comprise non-donating conductive materials.

### CROSS-REFERENCE TO RELATED APPLICATIONS

This application is a continuation-in-part of U.S. patent application Ser. No. 13/942,348 (Attorney Docket No. 18990.63) filed on Jul. 15, 2013, titled “Removing Ammonia from Water”, which is a continuation-in-part of U.S. patent application Ser. No. 13/872,044 (Attorney Docket No. 18990.62) filed on Apr. 26, 2013, titled “Producing Algae Biomass Having Reduced Concentration Of Contaminants”, which is a continuation-in-part of U.S. patent application Ser. No. 13/865,097 (Attorney Docket No. 18990.60) filed Apr. 17, 2013, titled “Harvesting And Dewatering Algae Using A Two-Stage Process”, which is a continuation-in-part of U.S. patent application Ser. No. 13/753,484 (Attorney Docket No. 18990.58), filed Jan. 29, 2013, titled “Systems And Methods For Harvesting And Dewatering Algae”, which claims priority to U.S. Provisional Patent Application No. 61/592,522 (Attorney Docket No. 18990.44), filed Jan. 30, 2012, titled “Systems And Methods For Harvesting And Dewatering Algae”, which claims priority to U.S. Provisional Patent Application No. 61/625,463 (Attorney Docket No. 18990.47), filed Apr. 17, 2012, titled “Solute Extraction From An Aqueous Medium Using A Modular Device”, and to U.S. Provisional Patent Application No. 61/649,083 (Attorney Docket No. 18990.48), filed May 28, 2012, titled “Modular Systems And Methods For Extracting A Contaminant From A Solution”. This application claims the benefit of these two provisional applications.

The disclosure of each of the applications to which the present application claims priority are incorporated by reference.

### BACKGROUND

Existing systems of wastewater treatment are limited to treating wastewater with bacterial digestion, oxidation, settling, and disinfection usually using chlorination. More advanced methods, such as ozone and ultraviolet radiation, also are used to treat water and wastewater.

Ammonium ions are a toxic waste product of the metabolism in animals. In fish and aquatic invertebrates, it is excreted directly into the water. Ammonia removal has attracted much attention in the past due to the need for the control of nitrogen nutrients to prevent eutrophication in a variety of water bodies. However, present technologies such as biological nitrogen removal, air stripping and ion exchange have several constraints including their inability to reduce ammonia to much lower levels, pollutant transfer into other media, and higher cost, among others.

Electrochemical processing has been explored as an alternative to existing methods for removing ammonia from wastewater. The successful use of electrochemical processing to remove ammonia has required a high concentration of chlorine anions (CV), whether initially present in the wastewater or added to the wastewater. When Cl⁻ is subject to an electric field, an electrochemical reaction converts it into the oxidizing agent hypochlorous acid (HOCl).

The removal mechanism of ammonia in the electrochemical process is poorly understood in terms of the oxidation route and reaction kinetics. A direct oxidation of ammonia occurs at electrode-liquid interfaces of the anode. The removal of ammonia also takes place through an indirect oxidation route by both hydroxyl radicals and HOCl formed in the electrochemical processes.

The chemical removal of ammonia compounds is achieved in stages. This process is referred to as Breakpoint chlorination and is illustrated in FIG. 1. The graph in FIG. 1 illustrates what happens to chlorine when it is added to water (whether as a chlorine gas or a hypochlorite). When chlorine enters water, it begins to react with compounds found in the water including reducing agents such as hydrogen sulfide and ferrous irons. These initial reactions produce chloride ions or hydrochloric acid which have no disinfecting properties. FIG. 1 illustrates this stage between points 1 and 2. As shown, there is no chlorine residual during this first stage.

As more chlorine is added to the water, the chlorine reacts with organics and ammonia naturally found in the water. During this second stage, illustrated as occurring between points 2 and 3, the reactions produce chloramines and therefore the chlorine residual increases.

In a third stage, between points 3 and 4, as more chlorine is added, the chlorine will react to break down most of the chloramines in the water that were produced during the second stage or otherwise present in the water. These reactions consume the chlorine thereby lowering the chlorine residual in the water.

Finally, at point 4, as more chlorine is added, the water reaches the breakpoint. The breakpoint is the point at which the chlorine demand has been totally satisfied (i.e. the chlorine has reacted with all reducing agents, organics, and ammonia in the water). When more chlorine is added past the breakpoint, the chlorine reacts with water and forms hypochlorous acid in direct proportion to the amount of chlorine added resulting in an increasing amount of chlorine residual.

There are various important factors in this breakpoint chlorination process that determine whether the process can be implemented in an efficient and satisfactory manner. These factors include: (1) the time it takes to reach the breakpoint; (2) the amount of chlorine that must be added to create an appropriate chlorine residual level; (3) the energy costs associated with the process; (4) the scalability of the process; and (5) the adaptability of the process to different types of water (e.g. fresh, city, brine, sea, and frac water).

In some prior art approaches (see, e.g. U.S. Pat. No. 7,736,776 to Spielman, et al.; European Patent No. 1,400,494 to Enpar Technologies, Inc.), various enhancements have been used to accomplish breakpoint chlorination with electrolysis. However, the systems proposed in these prior art approaches have limited flow rates due to, for example, constrictions generated by passing the flow through planar positioned electrodes, or requirements that additional pretreatment tanks be used. As a result, these prior art system are impractical for use at an industrial level where space and flow rates are critical.

### BRIEF SUMMARY

The present disclosure is generally directed to a system for treating wastewater. In some embodiments, the system comprises a series of interconnected reactor tubes. Each reactor tube comprises an outer cathode and an inner anode. The inner anode is positioned centrally within the outer cathode such that a spacing exists between an outer surface of the inner anode and an inner surface of the outer cathode. The system can also comprise a pump connected to an input of the reactor tubes. The pump can receive influent wastewater and can pump influent wastewater into and through the reactor tubes such that the wastewater flows between the inner anodes and the outer cathodes. The system can include a power supply to supply a voltage differential across the inner anodes and the outer cathodes to generate chlorine based elements within the wastewater. The chlorine based elements treat the wastewater.

In some embodiments, the system can include a feedback path to divert a portion of the wastewater with chlorine based elements back to an input of the pump so that the chlorine based elements are mixed with influent wastewater to increase the level of chlorine based elements available in the influent wastewater.

In other embodiments, the system can include an injector connected to an input of the pump. The injector can be configured to add chloride salts to the influent wastewater to generate chlorine based elements. The system can also include a monitor configured to determine the chloride salt concentration of the influent wastewater. The monitor can be further configured to activate the injector to add chloride salts to the influent wastewater based on the chloride salt concentration.

In yet other embodiments, system further comprises an oxidative reduction potential meter configured to measure the oxidative reduction potential of the treated wastewater. The meter can be configured to output a signal for controlling one or more of: an amount of chloride salts that are added to the influent wastewater; a rate at which the pump pumps wastewater through the reactor tubes; a voltage level applied by the power supply; or an amount of wastewater that is diverted back through the feedback path.

In some embodiments, the inner anode can comprise a non-donating conductive material. The non-donating conductive material can further comprise platinum, ruthenium, rhodium, palladium, osmium, iridium, or combinations thereof. The non-donating conductive material can further comprise titanium, carbon, conductive plastic, or combinations thereof.

In other embodiments, the outer cathode can comprise a non-donating conductive material. The non-donating conductive material can further comprise platinum, ruthenium, rhodium, palladium, osmium, iridium, titanium, carbon, conductive plastic, or combinations thereof.

This summary is provided to introduce a selection of concepts in a simplified form that are further described below in the Detailed Description. This Summary is not intended to identify key features or essential features of the claimed subject matter.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 depicts a graph of the breakpoint chlorination process;

FIG. 2 illustrates an example system for removing ammonia from wastewater using a series of MMO anodes;

FIG. 3A illustrates a cross-sectional front view of a reactor tube containing an inner anode centered between an outer cathode;

FIG. 3B illustrates a cross-sectional side view of the reactor tube;

FIG. 4 illustrate a flow-splitting valve used to provide a feedback path for diverting processed wastewater to be mixed with unprocessed wastewater;

FIG. 5 illustrates another example of a system for removing ammonia from wastewater using a series of MMO anodes;

FIG. 6A-6D illustrate various three-dimensional views of another example of a system for removing ammonia from wastewater using a series of MMO anodes;

FIG. 7 illustrates an example system for removing ammonia from wastewater using a series of reactors and chloride salt;

FIG. 8A illustrates a side view of an alternate configuration of an electrode;

FIG. 8B illustrates a cross-sectional view of an alternate configuration of an electrode;

FIG. 9 illustrates a perspective view of an electrode; and

FIG. 10 illustrates a system for treating wastewater.

### DETAILED DESCRIPTION

In U.S. patent application Ser. Nos. 13/942,348, 13/872,044, and 13/865,097, to which this application claims priority, embodiments were disclosed for removing ammonia from wastewater using electrodes made of a titanium ruthenium alloy or mixed metal oxide anodes (e.g. titanium core anodes having a coating of a metal in the platinum family such as ruthenium or iridium).

Prior application Ser. Nos. 13/872,044 and 13/865,097, to which this application claims priority, primarily describe a two-stage approach for harvesting algae. This two-stage approach includes a first stage flocculation tank which employs electrodes. In the prior application Ser. No. 13/942,348, reactor tubes similar to the flocculation tank described in Ser. No. 13/872,044 and Ser. No. 13/865,097 are employed in series to generate hypochlorite for breaking down ammonia in wastewater flowed through the reactor tubes. For the sake of brevity, the discussion of the two-stage approach is omitted from the description in this application in lieu of a specific description of how the reactor tubes can be configured to optimize ammonia removal in a quick manner.

The prior application Ser. No. 13/942,348 is generally directed to a system for reducing or eliminating ammonia from water using a series of reaction tubes that employ mixed metal oxide anodes. Each reaction tube can include an outer anode and an inner anode which are closely spaced to enhance the creation of chlorine residual (e.g. hypochlorite) within the reaction tubes. Additionally, a feedback path can be employed after the series of reaction tubes to route a portion of the water back to the input to the reaction tubes. This feedback path increases the amount of chlorine residual available in the water as it passes through the reaction tubes.

In some embodiments of prior application Ser. No. 13/942,348, water can be fed into the series of reaction tubes using an impeller pump which increases the interaction of the chlorine residual with the ammonia in the water by creating micron bubbles through cavitation. A mixing zone can also be positioned after the impeller pump to enhance the mixing of the micron bubbles within the water prior to being input into the series of reaction tubes. The presence of the micron bubbles containing the chlorine residual increases the surface area exposed to the ammonia thereby increasing the rate at which the ammonia is broken down. Accordingly, ammonia can be eliminated in a quick and energy efficient manner enabling high flow rates. In this way, the present invention can be used in virtually any industry as a practical means for eliminating ammonia from wastewater.

In one embodiment of prior application Ser. No. 13/942,348, the application is implemented as a system for removing ammonia from wastewater. The system includes a plurality of reactor tubes connected in series. Each reactor tube comprises an outer anode and an inner anode being positioned centrally within the outer anode such that a spacing between 3 mm and 10 mm exists between the outer surface of the anode and the inner surface of the cathode. At least one of the reactor tubes contains an inner anode having a mixed metal oxide (MMO) coating.

The system also includes a pump connected to an input of the plurality of reactor tubes. The pump receives unprocessed wastewater containing ammonia from a wastewater source and pumps the unprocessed wastewater into and through the series of reactor tubes.

The system also includes a power supply for supplying a voltage differential to the anode and the anode in each reactor tube thereby causing the generation of chlorine based elements within the unprocessed wastewater as the unprocessed wastewater passes through the reactor tubes. The chlorine based elements interact with the ammonia in the unprocessed wastewater to eliminate the ammonia thereby producing processed wastewater containing a reduced level of ammonia.

The system also includes a feedback path that diverts a portion of the processed wastewater that exits an output of the series of reactor tubes back to an input of the pump such that chlorine based elements contained in the processed wastewater are mixed with unprocessed wastewater to increase the level of chlorine based elements available in the unprocessed wastewater as the unprocessed wastewater passes through the reactor tubes.

In another embodiment of prior application Ser. No. 13/942,348, the application is implemented as a method for removing ammonia from wastewater. Unprocessed wastewater is received at a pump connected to a series of interconnected reactor tubes. Each reactor tube comprises an outer cathode and an inner anode being positioned centrally within the outer cathode such that a spacing between 3 mm and 10 mm exists between the outer surface of the anode and the inner surface of the cathode. At least one of the reactor tubes contains an inner anode having a mixed metal oxide (MMO) coating.

Chlorine based elements are injected into the unprocessed wastewater. The unprocessed wastewater containing the chlorine based elements is then pumped through the reactor tubes. A voltage differential is applied to the anode and cathode of each reactor tube to cause an interaction between the MMO coating and the chlorine based elements which produces additional chlorine based elements. The chlorine based elements interact with the ammonia to reduce the amounts of ammonia in the wastewater thereby producing processed wastewater.

A portion of the processed wastewater is then diverted from an output of the series of interconnected reactor tubes. The portion of the processed wastewater is diverted to an input to the pump such that chlorine based elements contained in the portion of the processed wastewater are supplied into unprocessed wastewater that is pumped into the series of interconnected reactor tubes.

In another embodiment of prior application Ser. No. 13/942,348, the application is implemented as a system for removing ammonia from wastewater. The system includes a plurality of reactor tubes connected in series. Each reactor tube comprises an outer cathode and an inner anode being positioned centrally within the outer cathode such that a spacing between 3 mm and 10 mm exists between the outer surface of the anode and the inner surface of the cathode. At least one of the reactor tubes contains an inner anode having a mixed metal oxide (MMO) coating.

The system also includes a hypochlorite source for injecting hypochlorite into unprocessed wastewater containing ammonia.

The system also includes a pump connected to an input of the plurality of reactor tubes. The pump receives the unprocessed wastewater and pumps the unprocessed wastewater into and through the series of reactor tubes. The pump causes cavitation to occur within the unprocessed wastewater which increases the mixing of the hypochlorite within the unprocessed wastewater.

The system also includes a power supply for supplying a voltage differential to the anode and the cathode in each reactor tube. The voltage differential causes the release of chlorine from the at least one MMO coated inner anode that interacts with the hypochlorite to produce additional hypochlorite. The hypochlorite interacts with the ammonia in the unprocessed wastewater to eliminate the ammonia thereby producing processed wastewater containing a reduced level of ammonia.

The system also includes a feedback path that diverts a portion of the processed wastewater that exits an output of the series of reactor tubes back to an input of the pump such that hypochlorite contained in the processed wastewater is mixed with unprocessed wastewater to increase the level of hypochlorite available in the unprocessed wastewater as the unprocessed wastewater passes through the reactor tubes.

System for Eliminating Ammonia from Wastewater

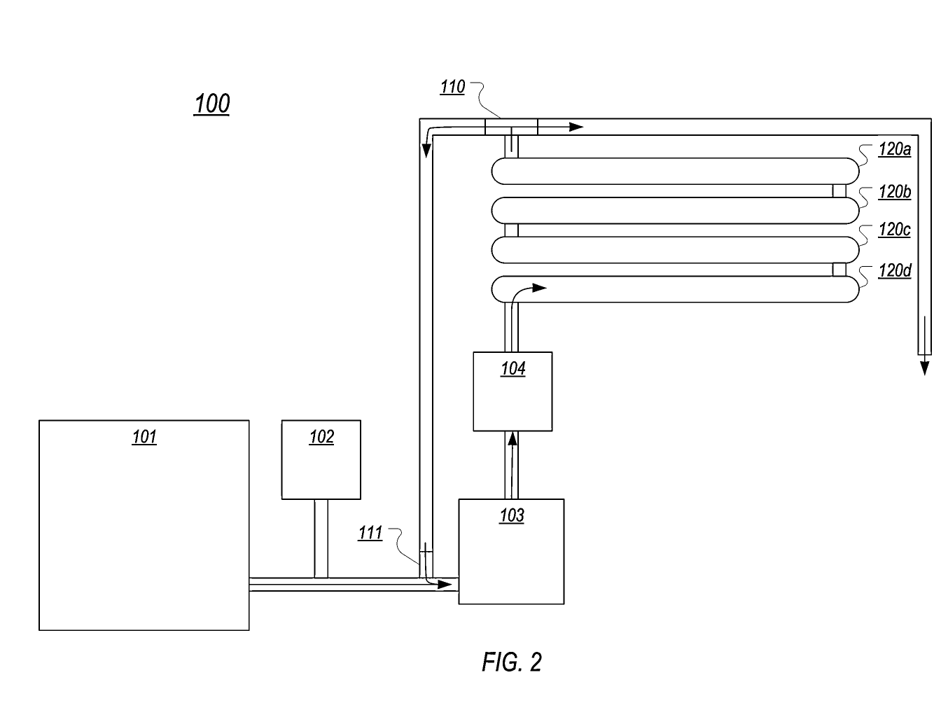

FIG. 2 illustrates an example system 100 that can be used to remove or reduce ammonia in a wastewater stream. System 100 includes a wastewater source 101 that supplies the wastewater containing ammonia. Wastewater source 101 can be any source of wastewater including ponds, streams, industrial plants, fish farms or suppliers, etc. The wastewater is fed into an impeller pump 103 which pumps the wastewater into a mixing area 104 and then through a series of reactor tubes 120a-120d (which will generally be identified with 120). Although four reactor tubes are shown in system 100, other numbers of reactor tubes can be used to accomplish a desired level of ammonia removal.

If the wastewater does not have a sufficient level of chlorine, a hypochlorite source 102 can supply hypochlorite (CIO⁻) to the wastewater stream prior to impeller pump 103. Although hypochlorite is primarily described as the source of chlorine that can be supplied to unprocessed water, other chlorine sources (or chlorine based elements) can also be used. Impeller pump 103 naturally causes cavitation in the wastewater which creates numerous micron bubbles containing hypochlorite. The mixing of these micron bubbles in the wastewater is increased within mixing area 104. Mixing area 104 may be any portion of the path between impeller pump 103 and the first reactor tube (e.g. reactor tube 120d). For example, mixing area 104 can be a tank or other container positioned inline between the two components or can simply be a length of the pipe connecting the two components. This mixing of the micron bubbles increases the rate of interaction of the hypochlorite and the ammonia as well as the rate of interaction of the hypochlorite and other chlorine based elements with the anodes.

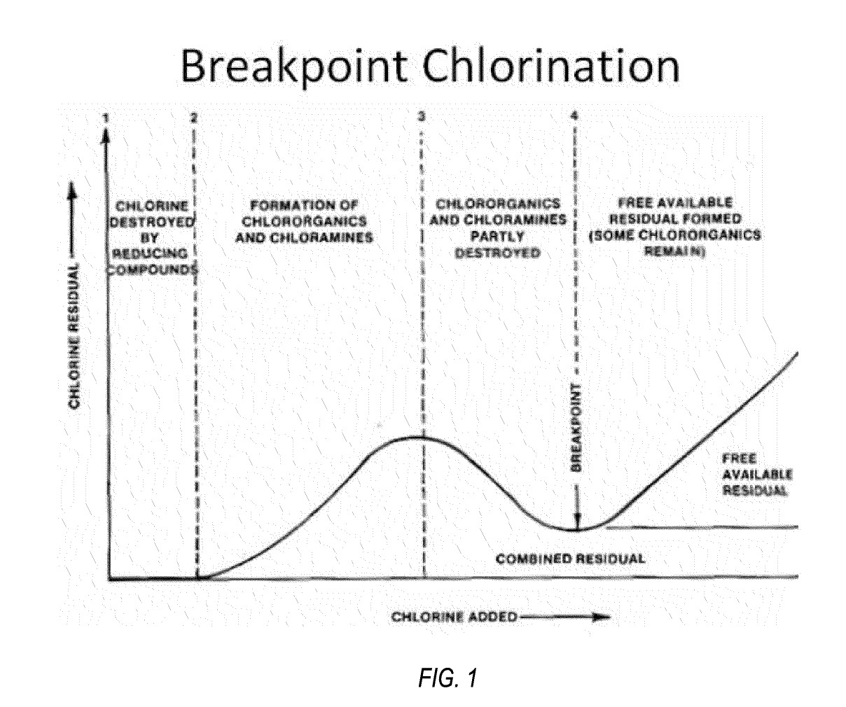

Each reactor tube 120 is comprised of an outer cathode forming the tube shape and an inner anode positioned centrally within the tube. In some embodiments, the outer cathode can be comprised of stainless steel and the inner anode can be comprised of a mixed metal oxide (MMO). In this specification MMO refers to an oxide comprised of metals in the platinum family including, but not limited to, iridium and ruthenium. In one example, an anode can be comprised of a titanium core with a MMO coating. When a voltage is applied to the MMO anode in the presence of ammonia and other chlorine based elements, hypochlorite is produced. Accordingly, the combination of the production of hypochlorite via electrolysis and the increased interaction due to the mixing of the micron bubbles in the wastewater speeds the breakpoint chlorination process depicted in FIG. 1. In other words, the time required to pass from point 1 to point 4 in FIG. 1 is increased by producing more chlorine residual (i.e. hypochlorite) and by increasing the rate of interaction of this chlorine residual with the ammonia. Therefore, the present invention can remove ammonia at a quicker rate and using less energy than in prior approaches allowing the present invention to be used to treat large amounts of wastewater quickly and efficiently.

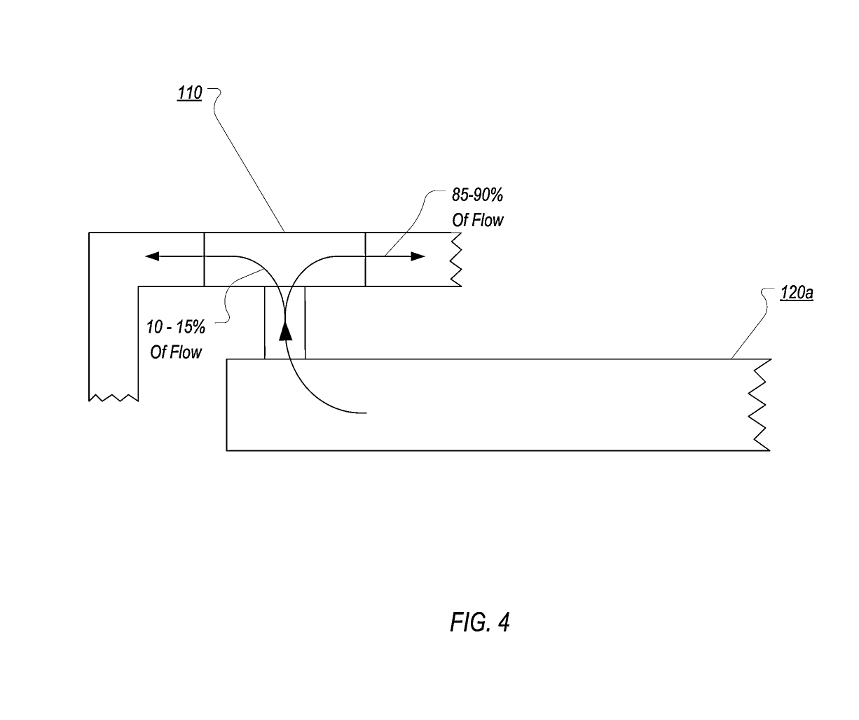

FIG. 2 also shows that system 200 includes a feedback loop comprised of a flow-splitting valve 110 and a one-way valve 111. Flow-splitting valve 110 causes a portion of the processed wastewater to be returned back to the input to impeller pump 103. In some embodiments, this portion can be 10-15% of the wastewater as shown in FIG. 4. However, any desired amount can be diverted back through the feedback loop. One-way valve 111 can prevent the unprocessed wastewater from flowing back into the feedback loop.

Because the processed wastewater contains an amount of residual hypochlorite (e.g. as shown by the rising curve after point 4 in FIG. 1), a portion of the processed wastewater can be returned to act as an additional source of hypochlorite. In this way, the amount of hypochlorite available within the wastewater passing through reactor tubes 120 can be increased without requiring the additional input of hypochlorite (e.g. via hypochlorite source 102). In other words, by returning a portion of the processed wastewater through the feedback path, the amount of hypochlorite can be gradually increased further increasing the speed at which the ammonia is removed.

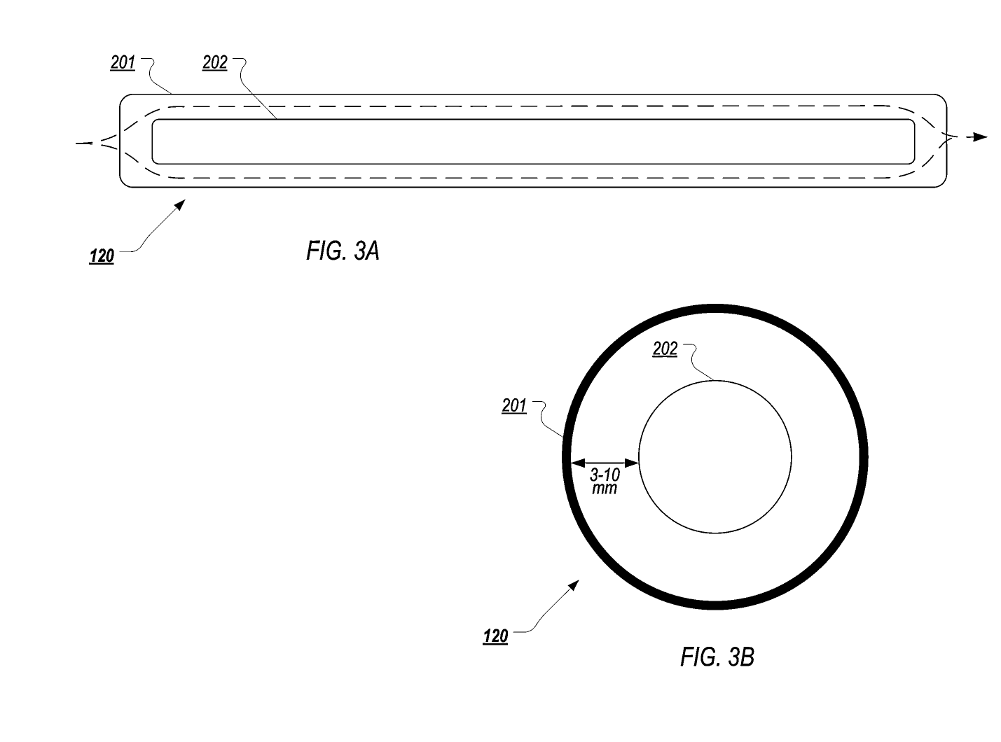

FIGS. 3A and 3B illustrate a cross-sectional front and side view respectively of a reactor tube 120. As shown in FIG. 3A, an inner anode 202 is centrally positioned within an outer cathode 201 to create a narrow pathway around the circumference of anode 202 through which the wastewater can flow (as indicated by the arrow). Inner anode 202 is coated with a MMO.

As shown in FIG. 3B, in some embodiments, the spacing between cathode 201 and anode 202 can be between 3 and 10 mm with an optimal exact spacing being dependent on the conductivity of the wastewater. A spacing within the 3-10 mm range has proven to be optimal for the creation of hypochlorite via electrolysis within wastewater containing ammonia. Specifically, with this spacing, when an electric current flows through the MMO coated anode 202, hypochlorite is generated from the reaction of elements released from the MMO coated anode 202 and elements in the wastewater such as chlorine, brine, chloramines, calcium chloride, or any other chloride salt. In cases where such elements are not sufficiently present in the wastewater prior to processing, hypochlorite (or another chlorine based element) can be added via hypochlorite source 102 to ensure that sufficient hypochlorite is generated during electrolysis. However, if sufficient chlorine based elements are present in the wastewater prior to processing, no hypochlorite may need to be added.

As noted, the presence of hypochlorite in the wastewater can increase the production of additional hypochlorite during electrolysis. Accordingly, by returning a portion of the wastewater post electrolysis, an additional amount of hypochlorite is continuously added into the process without requiring an external source of hypochlorite. This allows for the buildup of hypochlorite present within the reactor tubes 120 thereby increasing the speed at which ammonia is eliminated.

As also noted, impeller pump 103, which has a natural propensity to cause cavitation, generates micron bubbles of hypochlorite (and generally micron bubbles of oxygen and hydrogen as well). The micron bubbles blend with the wastewater enhancing the interaction of the hypochlorite with the ammonia as well as the interaction of the hypochlorite with the MMO coated anode 202. This results in an increased rate of ammonia breakdown due to both the increased interaction between the hypochlorite and the ammonia and to the increased production of additional hypochlorite through the interaction between the hypochlorite and the MMO coated anode 202. In some tests, it has been found that a flow rate of thirty seconds or less (i.e. the wastewater flows through the series of reactor tubes 120 in thirty seconds or less) is sufficient to eliminate ammonia.

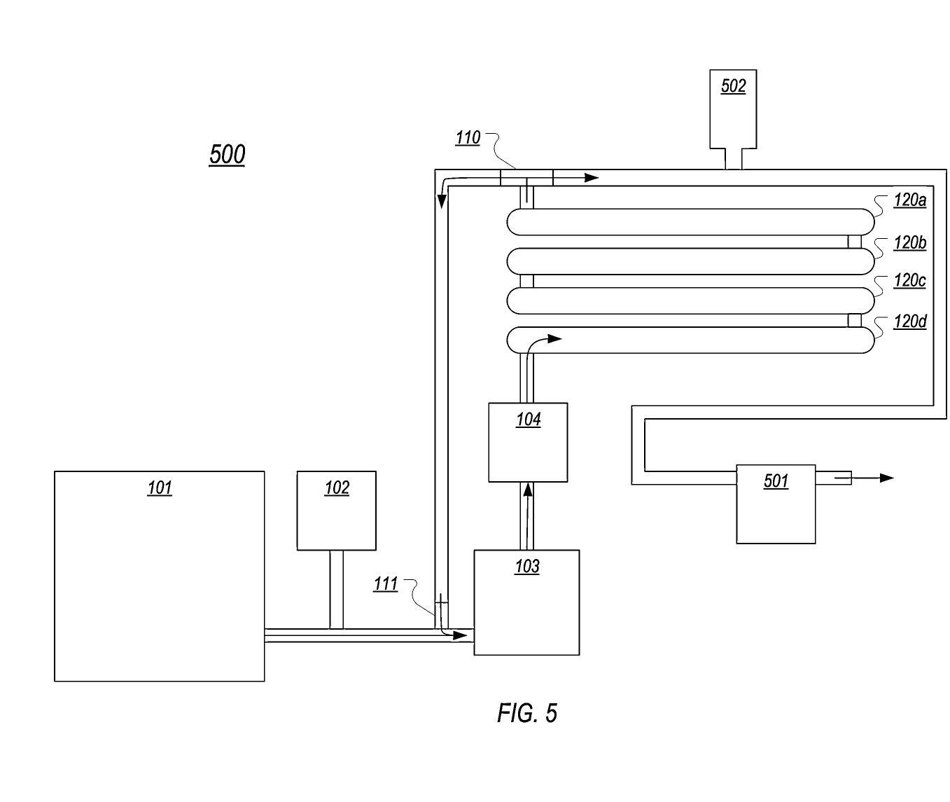

In some embodiments of the invention, the ammonia breakdown process can be automated by monitoring the oxidation reduction potential (ORP) of the wastewater. FIG. 5 illustrates another embodiment of a system 500 that includes an ORP meter 502 for monitoring the ORP of the wastewater after the wastewater passes through the series of reactor tubes 120. It has been determined that when breakpoint chlorination occurs, the ORP of the wastewater is around 750 mV. By using the ORP metric, a system can be tuned to process wastewater at a desired rate. For example, the ORP of the wastewater can be measured prior to testing (e.g. using an ORP meter (not shown) positioned upstream from the series of reactor tubes 120 such as in wastewater source 101 or in the flow path of system 500) to identify a relative amount of ammonia in the wastewater. Based on this initial ORP and a desired time for eliminating the ammonia from the wastewater, it can be determined how much hypochlorite (or other chlorine based element) must be added to the wastewater (e.g. via hypochlorite source 102) to achieve ammonia elimination in the desired time.

Similarly, ORP readings can be taken during processing to determine if the rate at which hypochlorite is added should be adjusted. For example, it can be determined from the ORP reading whether too much hypochlorite is being added (e.g. when the processed wastewater contains an excess amount of hypochlorite), and if so, the rate at which hypochlorite is being added can be reduced to conserve hypochlorite and/or to minimize the amount of free hypochlorite in the treated wastewater. Similarly adjustments could be made to increase the amount of hypochlorite added (e.g. when the ORP reading of the processed wastewater is below 750 mV).

As also shown in FIG. 5, in some embodiments of the invention, one or more post-processing filters 501 can be included to remove the chlorine (e.g. hypochlorite) from the processed wastewater. Filters 501 can include activated carbon filters, clay filters, or mineral filters such as Zeolite or Diatomaceous earth filters. For example, in some embodiments, one or more granular activated carbon (GAC) filters and/or one or more copper-zinc based filters can be used.

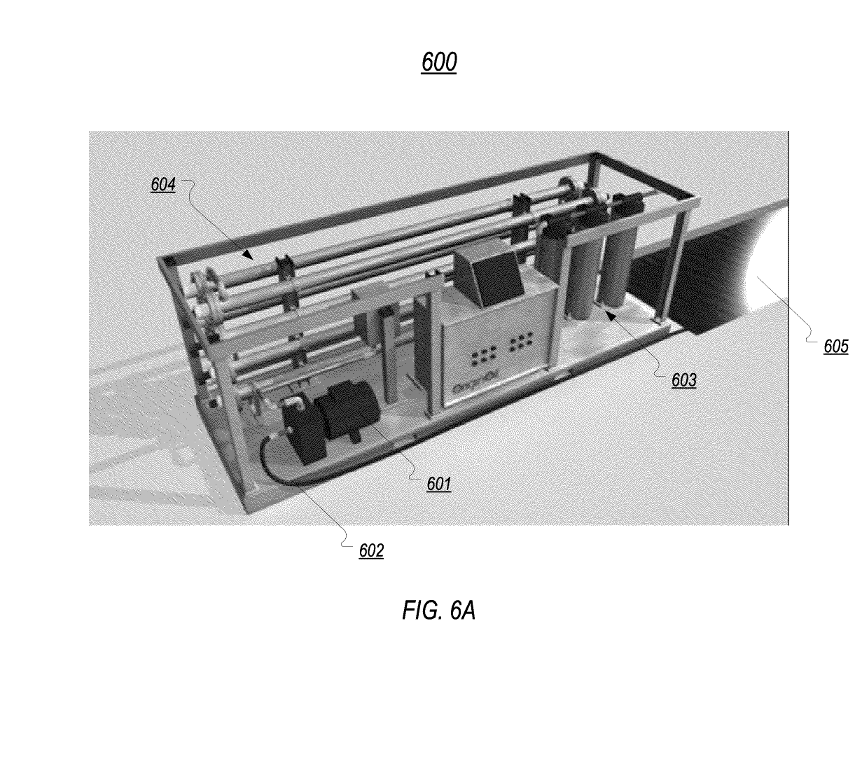

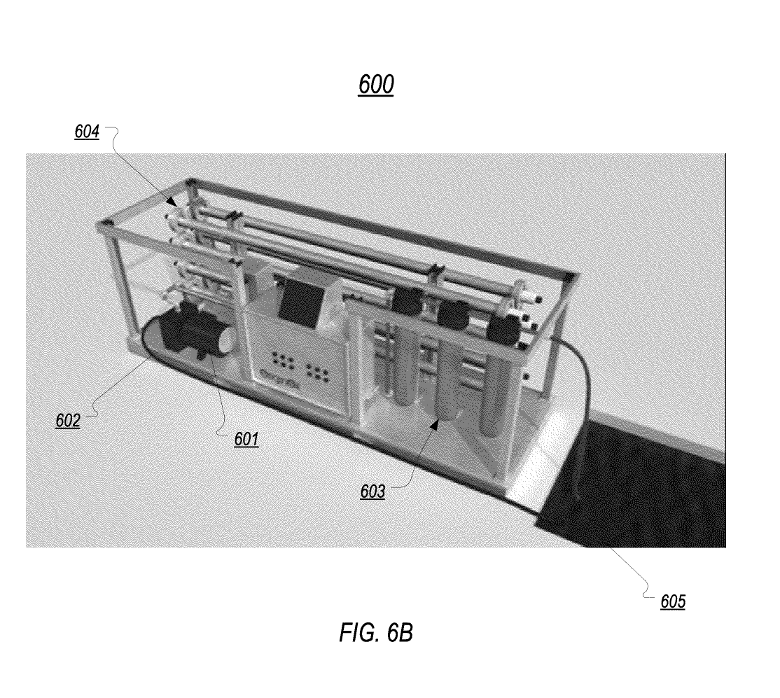

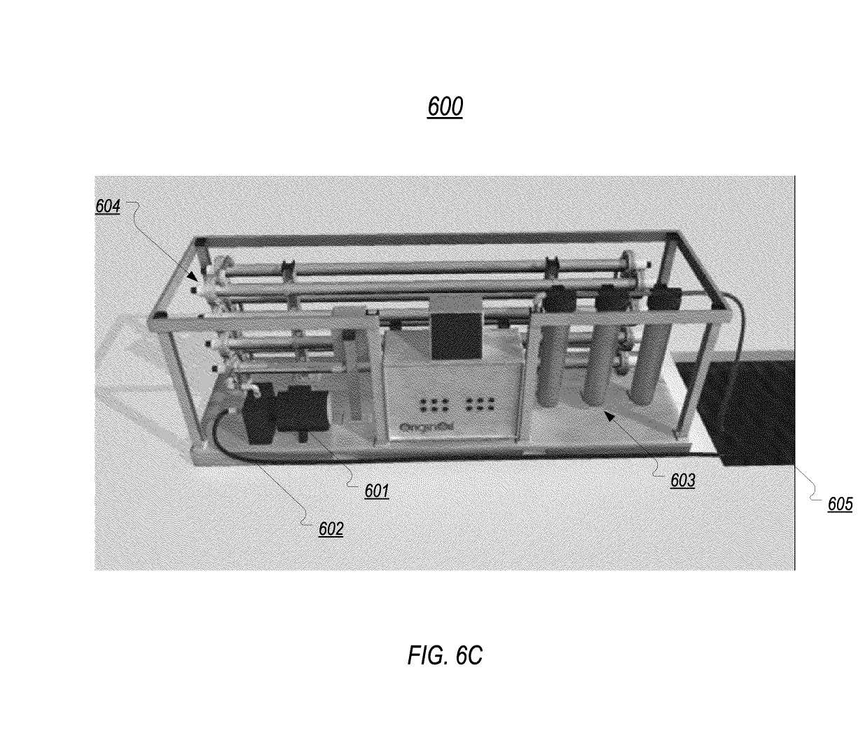

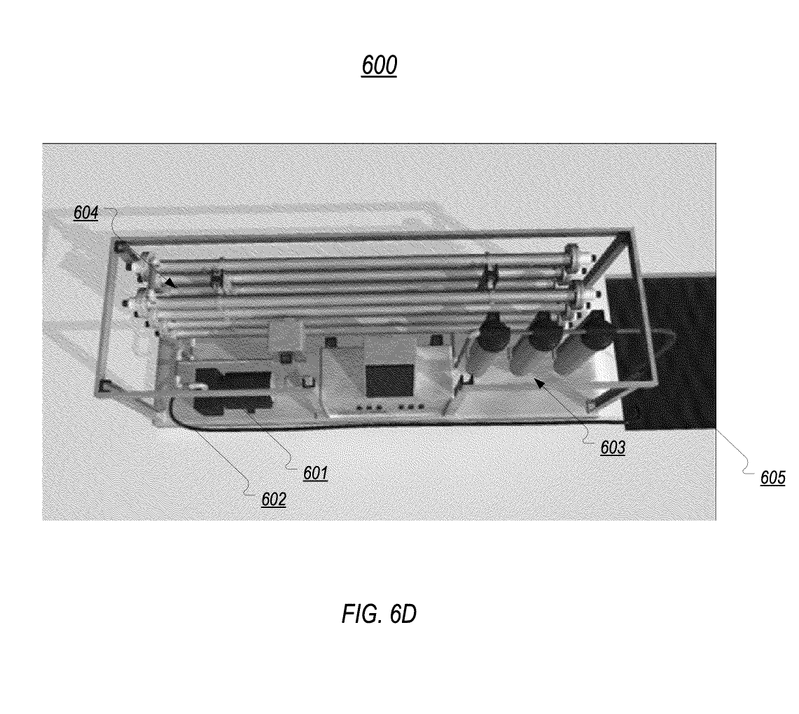

FIGS. 6A-6D each illustrate a different view of another example embodiment of a system 600 for removing ammonia from wastewater. As shown, system 600 includes an impeller pump 601, an input 602 that supplies wastewater from a wastewater source 605, an array of reactor tubes 604, and a post processing filtration unit 605. System 600 is an example where the output of the system is fed back into the wastewater source. As such, system 600 can represent using the present invention to decontaminate a wastewater source such as a lake, pond, or other body of water.

Using the System with Salt Solution in Place of Hypochlorite

In some embodiments, the above described system 100 can also be used with a chloride salt solution in place of hypochlorite. Example 2 below illustrates test results of an example system configured to be used with a chloride salt solution in place of hypochlorite.

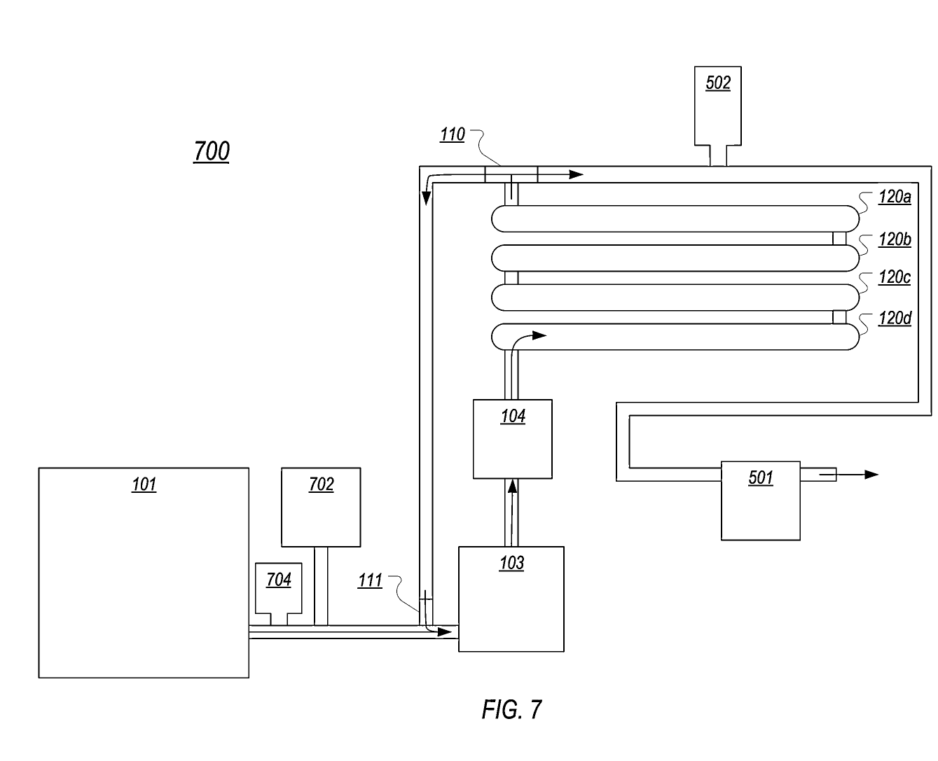

In some embodiments, a chloride salt solution can be mixed with the influent wastewater and then flowed through the reactor tubes. In the reactor tubes, electro-oxidation of the chloride salt generates chlorine dioxide. To use the system with a salt solution in place of hypochlorite, a chloride salt solution can be added to the wastewater in place of the hypochlorite. FIG. 7 illustrates embodiments of a system 700 that includes an injector 702 configured to inject chloride salt into the influent wastewater stream. In some embodiments, the injector 702 can comprise a dosing pump configured to inject a chloride salt solution into the influent wastewater stream. In other embodiments, a sodium chloride solution can be injected into the influent wastewater stream. In alternate embodiments, the system 700 can include a monitor 704 configured to determine the chloride salt concentration of the influent wastewater. The monitor 704 can determine if the chloride salt concentration of the influent wastewater is sufficient for the generation of chlorine dioxide. If the chloride salt concentration is insufficient, the monitor 704 can activate the injector 702 to inject chloride salt into the influent wastewater stream to increase the chloride salt concentration. If the chloride salt concentration is sufficient, no additional chloride salt is injected into the influent wastewater stream. Any added chloride salt can further mix with the influent wastewater stream in the impeller pump 103 and mixing area 104. The influent wastewater stream with chloride salt enters the reactor tubes 120 where electro-oxidation generates chlorine dioxide.

In some embodiments, chloride salt can include any compound comprising chloride ions. In other embodiments, chloride salt can include any compound comprising chloride ions that is soluble in water. In yet other embodiments, chloride salt can include any compound comprising chloride ions and any ion from group 1 or group 2 of the periodic table. In some embodiments, chloride salts comprise lithium chloride, sodium chloride, potassium chloride, magnesium chloride, calcium chloride, or combinations thereof.

In some embodiments, a chloride salt can be added to the wastewater source to raise the level of chloride salt to about 0.9 g/l. The injector 702 can be configured as a dosing pump to inject a chloride salt solution of about 120 g/l into the influent wastewater stream. In other embodiments, the injector 702 can comprise a venturi.

In other embodiments, the monitor 704 can be configured to determine the salinity of the influent wastewater. In alternate embodiments, the monitor 704 can be configured to determine the conductivity of the influent wastewater stream.

In another embodiment, the system 700 can further comprise sensors to monitor and/or adjust temperature, pressure, ammonia concentration, chlorine dioxide concentration, pH, dissolved oxygen, dissolved gases, dissolved solids, turbidity, COD, BOD and/or conductivity.

Using the System to Convert Ammonia to Nitrate

The above described system can also be used to convert ammonia into nitrate. To convert ammonia to nitrate, sodium hypochlorite (NaClO) or Calcium Hypochlorite (Ca(ClO)₂) can be added to the wastewater in place of the hypochlorite. Then, the wastewater can be treated at a rate that results in the ORP of the wastewater being less than 600 mV. At this ORP, the ammonia in the wastewater is in an oxidized form which is converted into nitrate according to the following equations:

2Cl⁻→Cl₂+2e⁻(occurs at the anode during electrolysis) (1)

Cl2+H2O→HOCl+H⁺+Cl⁻ (2)

HOCl+(2/3)NH₃→(1/3)N₂+H₂O+H⁺+Cl⁻ (3)

HOCl+(2/3)NH₄⁺→(1/3)N₂+H₂O+(5/3)H⁺+Cl⁻ (4)

HOCl+(1/4)NH₄⁺→(1/4)NO₃⁻+(1/4)H₂O+(3/2)H⁺+Cl⁻ (5)

HOCl+(1/2)OCl⁻→(1/2)ClO₃⁻+H⁺+Cl⁻ (6)

NH₃+H₂O+NaClO→NH₂+H₂O+NaCLO+H→NH⁺+H₂O+NaClO→NO₂⁻8H⁺+NaClO (7)

NO₂⁻+H₂O+NaCl→NO₃⁻+2H⁺+NaCl (8)

It has been found that a current density of between 30-50 mA/cm² of the cathode is generally preferred to maximize the oxidation of the ammonia into nitrate and nitrite. However, other current densities can also be used, and the ideal density will depend on various characteristics such as the temperature of the wastewater.

In some embodiments, a nitrate rich broth containing desired metals (which may be used for fertilizer production) can be created by including the desired metals in the MMO coating of one or more of anodes 202. For example, one or more of iron, copper, manganese, molybdenum, zinc, or nickel can be added to an MMO coating. Similarly, one or more of the MMO coated anodes 202 can be replaced with an anode being coated with one or more desired metals. In a particular example, half of the reactor tubes 120 can include MMO coated anodes 202 and the other half of the reactor tubes 120 can include iron coated anodes.

Example Compositions Of the Electrodes

The electrodes (i.e. cathode 201 and anode 202) can be made of a metal, composite, or other material known to impart conductivity, such as, but not limited to silver, copper, gold, aluminum, zinc, nickel, brass, bronze, iron, lead, platinum group metals, steel, stainless steel, carbon allotropes, and/or combinations thereof. Non-limiting examples of conductive carbon allotropes can include graphite, graphene, synthetic graphite, carbon fiber (iron reinforced), nano-carbon structures, and other form of deposited carbon on silicon substrates. In some configurations, the anode and/or the anode can serve as a sacrificial electrode which is used in the flocculation and/or bubble generation processes. As such, electrodes can include consumable conductive metals, such as iron or aluminum.

In some embodiments, anodes 202 can be comprised of a catalyst-coated metal such as iridium oxide coated titanium. Such metals can enhance the efficiency of the process. For example, by using iridium oxide coated titanium on the anode, the creation of gas bubbles containing chlorine (e.g. hypochlorite) can be facilitated.

In some embodiments, the cathode 201 and/or anode 202 can comprise a non-metal ion donating (non-donating) conductive material. In these embodiments, the use of non-donating conductive materials for the electrodes can avoid decay of the electrodes and can reduce the need to replace electrodes and the need to remove decayed metal ions in the treated water. In some embodiments, the cathode 201 and/or anode 202 can comprise a support substrate coated with a non-donating material.

In some embodiments, the anode material can comprise a non-donating conductive material such as a noble metal including platinum, ruthenium, rhodium, palladium, osmium, iridium, or combinations thereof. In other embodiments, the anode material may comprise materials such as Ti. In alternate embodiments, the anode material may comprise carbon or conductive plastics such as polyethyne. In yet other embodiments, the anode material may comprise any donating metal sufficient to promote electrolysis. In some embodiments, the anode material may comprise a ceramic coated with and/or embedded with a non-donating conductive material.

In some embodiments, the cathode material can comprise noble metals such as platinum, ruthenium, rhodium, palladium, osmium, iridium, or combinations thereof. In other embodiments, the cathode material can comprise stainless steel. In yet other embodiments, the cathode material may comprise any donating metal sufficient to promote electrolysis. In another embodiment, the cathode material may comprise carbon or a conductive plastic such as polyethyne. In some embodiments, the cathode material may comprise a ceramic coated with and/or embedded with a non-donating conductive material.

Configuration of Reactor Tubes

In other embodiments, modified reactor tubes 120 can be configured with outer electrodes having a plurality of apertures. In some embodiments, a modified reactor tube 120 with an outer electrode having a plurality of apertures can be configured to be housed within a flow cell that can be configured to allow wastewater to contact and flow past the modified reactor tube 120. In other embodiments, the flow cell can then be incorporated into any of the embodiments of this application. In yet other embodiments, the modified reactor tubes 120 can be configured to be directly in contact with the wastewater. In some embodiments, the modified reactor tubes can be assembled as an array and configured as part of a flow cell or configured to be directly in contact with the wastewater.

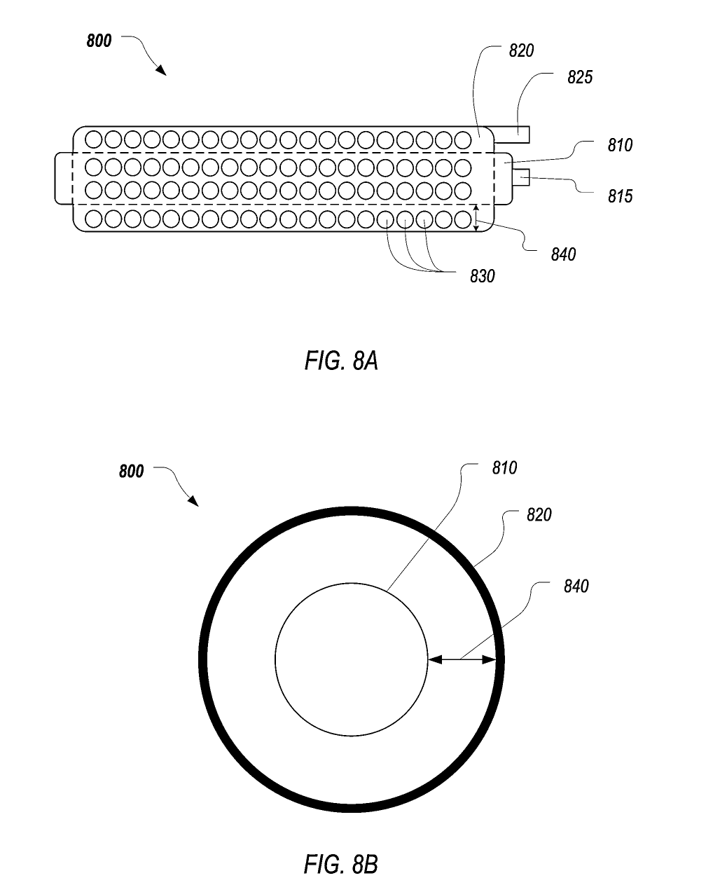

FIGS. 8A and 8B illustrate side and cross-sectional views of some embodiments of an example electrode assembly 800 that can comprise an outer electrode with a plurality of apertures. The modified reactor tubes 120 described above can be configured with the electrode assembly 800. As shown in FIG. 8A, the electrode assembly 800 can comprise an inner electrode 810 and an outer electrode 820 that can be configured to sheath the inner electrode 810. The outer electrode 820 can comprise a plurality of apertures 830. The inner electrode 810 and the outer electrode 820 can be configured such that a spacing 840 is maintained between the inner electrode 810 and the outer electrode 820. The inner electrode 810 can further comprise an inner electrode connector 815 configured to be connected to a power supply. The outer electrode 820 can further comprise an outer electrode connector 825 configured to be connected to a power supply. FIG. 8B shows a cross-sectional view of the electrode assembly 800. Cross-sectional views of the inner electrode 810, the outer electrode 820, and the spacing 840 are visible.

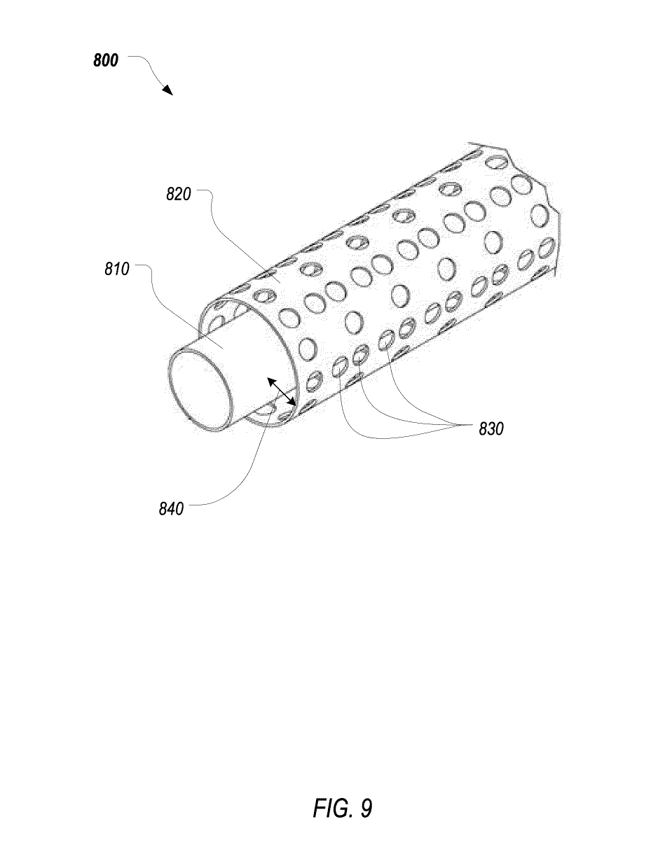

FIG. 9 illustrates a perspective view of some embodiments of an example electrode assembly 800. The inner electrode 810, the outer electrode 820, plurality of apertures 830 and the spacing 840 are illustrated.

In some embodiments, both the inner electrode 810 and the outer electrode 820 can be configured with a nested cylinder arrangement. The inner electrode 810 can be configured as an anode and can comprise a non-donating conductive material. This non-donating conductive material can comprise a noble metal such as platinum, ruthenium, rhodium, palladium, osmium, iridium, or combinations thereof. The outer electrode 820 can be configured as a cathode and may comprise stainless steel or similar material. The apertures 830 can comprise a pattern of round holes in the outer electrode 820. The spacing 840 can range from about 1 mm to about 9 mm.

In some embodiments, the spacing 840 can range from about 0.05 mm to about 15 mm. In other embodiments, the spacing 840 can range from about 0.1 mm to about 12 mm. In alternate embodiments, the spacing 840 can range from about 0.1 mm to about 10 mm. In yet other embodiments, the spacing 840 can range from about 1 mm to about 5 mm.

In other embodiments, the inner electrode 810 and the outer electrode 820 can be configured with a nested cylinder arrangement, with the inner electrode 810 configured as a cylinder that is centrally positioned within the outer electrode 820 and the outer electrode 820 also configured as a cylinder. In some embodiments, the inner electrode 810 can be configured as a rectangular solid with a cross-sectional shape of a square and with the outer electrode 820 similarly configured. In other embodiments, the inner electrode 810 and the outer electrode 820 can be configured as a solid shape with a trapezoidal cross-section. In yet another embodiment, the inner electrode 810 can be configured as a plurality of electrodes that are sheathed by the outer electrode 820. In some embodiments, the inner electrode 810 may not be centrally positioned within the outer electrode 820. In other embodiments, the inner electrode 810 can be configured as an elongated flat sheet. In another embodiment, the inner electrode 810 can be configured as a curved sheet. In other embodiments, the inner electrode 810 can be configured as a cylinder with an ellipsoid cross-section.

In some embodiments the inner electrode 810 can be configured as an anode and the outer electrode 820 can be configured as a cathode. In another embodiment, the inner electrode 810 can be configured as a cathode and the outer electrode can be configured as an anode.

In some embodiments, the apertures 830 can comprise circular cutouts in the outer electrode 820. In other embodiments, the apertures 830 can comprise cutouts of other shapes. In other embodiments, the apertures 830 can be configured in size and density to produce chlorine dioxide at certain voltages, amperages, and currents. In another embodiment, the apertures may be configured as a mesh, screen, or braided arrangement. In yet other embodiments, the outer electrode 820 and the apertures 830 can be configured as a welded wire mesh, a woven wire mesh, a coated wired mesh, a cage mesh, a wire cloth mesh, and/or a hexagonal netting mesh. In alternate embodiments, the outer electrode 820 and the apertures 830 can be configured as expanded metal, flattened expanded metal, hexagonal expanded metal, square expanded metal, micro expanded metal, and/or ribbon mesh expanded metal.

Remediation of Other Contaminants from Wastewater

In addition to ammonia, the present invention can be employed to remove other contaminants from wastewater such as antibiotics, hormones, active inorganic chemicals (e.g. via reduction chemistry), and bacteria. Such contaminants can be removed from wastewater that also contains ammonia or that does not contain ammonia using the techniques described above. As wastewater containing such contaminants passes through the system of the present invention, the interaction of the chlorine based elements and/or the electric field with the contaminants causes them to break down into less harmful or harmless elements. Accordingly, wastewater treated using the techniques of the present invention can become more suitable for subsequent use such as for use as water for fisheries, for use as a growth medium (e.g. for algae or another useful organism), and other suitable uses.

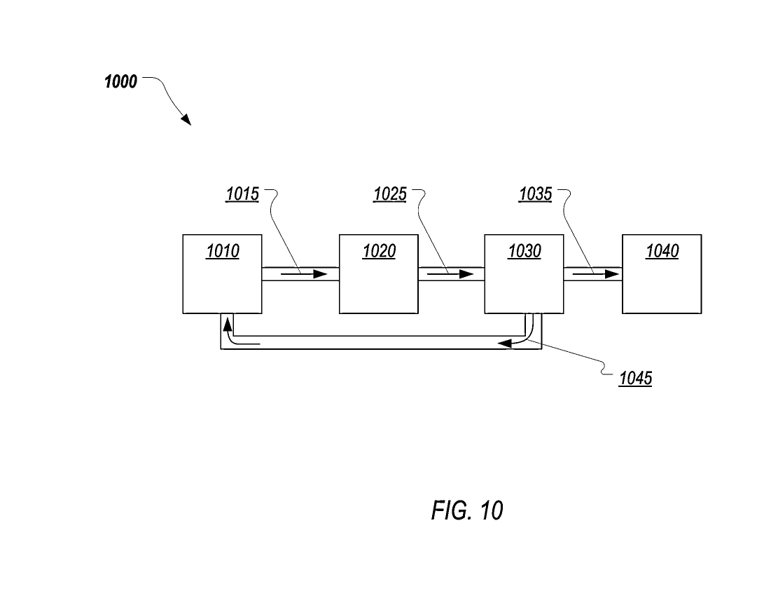

FIG. 10 illustrates an example system for treating wastewater. First, wastewater can be produced or provided 1010. In some embodiments, wastewater can be produced 1010 from a hydraulic fracturing operation 1010. Next, the wastewater can be delivered 1015 to an optional pretreatment step 1020. After the optional pretreatment step 1020, the wastewater can be delivered 1025 to an electrowater separation step 1030. Then the treated wastewater can be delivered 1035 to further treatment steps 1040. Optionally, the treated wastewater can be delivered 1045 for reuse. In some embodiments, the wastewater produced from the hydraulic fracturing operation 1010 can include produced water, flowback water, and/or impounded water. In other embodiments, the waste water can comprise an oil/water emulsion, bacteria, and/or other contaminants. In some embodiments, the optional pretreatment step 1020 can include gravity separation in a holding tank, separation in a skim tank, and/or treatment in an API gunbarrel system. In yet other embodiments, the pretreatment step can include treatment by gravity separation, chemical means, filtration, centrifugation, and/or any other appropriate pretreatment method.

In some embodiments, the electrowater separation step 1030 can comprise any one or any combination of the systems 100, 500, or 700, described herein. In other embodiments, the electrowater separation step 1030 can further comprise the two stage electrocoagulation and electro-flotation process disclosed in prior application Ser. Nos. 13/942,348, 13/872,044, and 13/865,097. In alternate embodiments, the electrowater separation step 1030 can break up oil/water emulsions, remove up to 99% of dispersed oil and suspended solids, and/or kill bacteria and viruses. In yet other embodiments, the electrowater separation step 1030 can break up oil/water emulsions by neutralizing the repulsive charges of the oil droplets and suspended solids to allow them to agglomerate. In other embodiments, the electrowater separation step 1030 can remove organics by as much as 99.9% and total suspended solids by as much as 99.5%.

In other embodiments, the electrowater separation step 1030 can comprise any one of: deoiling to remove free and dispersed oil and grease; soluble organics removal to remove dissolved organics; disinfection to remove bacteria and other microorganisms; suspended solids removal to remove suspended particles, sand, and/or turbidity; dissolved gas removal to remove light hydrocarbon gases, carbon dioxide, hydrogen sulfide, and other gases; desalination or demineralization to remove dissolved salts, sulfates, nitrates, contaminants, scaling agents and other minerals; softening to remove excess water hardness; sodium adsorption ratio (SAR) adjustment to add calcium or magnesium ions to the treated water to adjust sodicity levels prior to use for irrigation; and/or removal of naturally occurring radioactive materials. In yet other embodiments, the electrowater separation step can remove up to 99% of suspended particles in the 10-25 μm range. In alternate embodiments, the electrowater separation step can remove up to 99% of dispersed oil in the 10-25 μm range.

In other embodiments, the further treatment steps 1040 can comprise one or more additional electrowater separation steps 1030. In another embodiment, the further treatment steps 1040 can comprise any combination of filtration, microfiltration, ultrafiltration, nanofiltration, reverse osmosis treatment, and/or chemical treatment. In yet other embodiments, the further treatment steps 1040 can comprise any combination of treatment steps to generate potable water.

In some embodiments, the delivery steps 1015, 1025, 1035, and 1045 can be carried out by plumbing, pipes, tubing, hosing, or other fluid conveyance systems configured to deliver the wastewater. In other embodiments, the delivery steps 1015, 1025, 1035, and 1045 can further comprise storage ponds, storage reservoirs, holding tanks or storage tanks. In alternate embodiments, the delivery steps 1015, 1025, 1035, and 1045 can further comprise shipping by vehicle such as tanker truck, tanker rail car and/or tanker shipping.

In some embodiments, the wastewater can be produced water from oil and gas drilling operations. The produced water may be a byproduct produced along with oil and gas. In alternate embodiments, the produced water may be from waterflooding to increase oil production. In other embodiments, the produced water can be highly contaminated with hydrocarbons and drilling chemicals.

In other embodiments, the wastewater can be wastewater from industrial water. In some embodiments, the industrial wastewater can include cooling towers, process water, and mill water. In some embodiments, the wastewater can be industrial water and the electrowater separation step 1030 is configured to control odors in the industrial wastewater and to remove bacteria and other microorganisms from the industrial wastewater. In yet other embodiments, the electrowater separation step 1030 can be configured to control odor by removing odor-causing microorganisms and by destroying hydrogen sulfide odors through chemical oxidation by generation of chlorine dioxide. In some embodiments, the electrowater separation step 1030 can be configured to generate chlorine dioxide for pulp bleaching and/or to treat industrial wastewater from pulp bleaching operations. In other embodiments, the electrowater separation step 1030 can be configured for effective nitrification control. In some embodiments, the electrowater separation step 1030 can be configured for zebra mussel control.

In some embodiments, the wastewater can be industrial wastewater from cooling loops including cooling tower operations. The operation of cooling towers can lead to the buildup of microorganisms in the resultant industrial wastewater. Control of the buildup of the resultant microorganism is important for the efficient operation of the cooling loop. The buildup of resultant microorganisms can lead to the formation of slime layers, colonies of microorganisms, increased deposits in the cooling system, buildup of odors, loss of heat transfer due to the insulating nature of the deposits, increased corrosion rates, and increased consumption of power due to flow restriction caused by deposits. In other embodiments, the electrowater separation step 1030 can be configured to treat cooling loop wastewater and may comprise any one or any combination of the systems 100, 500, or 700, described herein and/or the two stage electrocoagulation and electro-flotation process disclosed in prior application Ser. Nos. 13/942,348, 13/872,044, and 13/865,097. The electrowater separation step 1030 can be configured to treat cooling loop wastewater by generating chlorine dioxide to remove microorganisms and to control odors including hydrogen sulfide odors. Treating the cooling loop wastewater by the generation of chlorine dioxide reduces the buildup of microorganisms, reduces the formation of slime layers, decreases deposits in the cooling system, reduces the buildup of odors, reduces the loss of heat transfer, and reduces power consumption. In other embodiments, after treatment by the electrowater separation step 1030, the treated water can be returned 1045 to the cooling loop.

### Example 1

A first test was performed on wastewater that was used as live fish transport water and had become highly ammoniated. A system similar to system 500 shown in FIG. 5 was used to process the wastewater. For example, four 4′ long reactor tubes were connected in series with a feedback path connecting the output of the series of reactor tubes back to the input of the pump. Each reactor tube included a stainless steel outer cathode. Two of the reactor tubes (the first two in the series) included MMO anodes while the other two (the last two in the series) included iron anodes. The anodes in each reactor tube were centrally positioned with a 9 mm gap between the inner surface of the cathode and the outer surface of the anode.

A 15 GPM pump was used (e.g. as pump 103) and was driven at 14 GPM using a 12 volt power supply (requiring approximately 528 watts (528 W=8 V*66 A)). Because the wastewater already contained NaCl, no hypochlorite (or other chlorine based element) was added to the wastewater. A post processing filtration unit consisting of 2 GAC filters and 2 copper-zinc based filters (supplied by KDF Fluid Treatment of Three Rivers, Mich.) was used to remove hypochlorite from the processed wastewater.

The wastewater was treated for roughly 30 seconds. The wastewater was sampled at four points: (1) prior to being processed through the reactor tubes; (2) after being processed through the first two reactor tubes containing the MMO coated anodes; (3) after being processed through the last two reactor tubes containing the iron coated anodes; and (4) after being processed through the post processing filtration unit. The following tables list the readings for pH, ORP, conductivity, total dissolved solids (TDS), nitrate level, and ammonia level at these four points.

| | pH | ORP | Conductivity | TDS | Nitrate | Ammonia |
|---|---|---|---|---|---|---|
| At | 7.93 | 397 mV | 5287 μS | :4130 | +/−10 ppm | 9.98 mg/l |
| point 1 | | | | | | |

| | pH | ORP | Conductivity | TDS | Nitrate | Ammonia |
|---|---|---|---|---|---|---|
| At | 7.66 | 733 mV | 4869 μS | 3767 | +/−10 ppm | 1.5 mg/l |
| point 2 | | | | | | |

| | pH | ORP | Conductivity | TDS | Nitrate | Ammonia |
|---|---|---|---|---|---|---|
| At | 7.66 | 750 mV | 3888 μS | 2941 | +/−40 ppm | 0 mg/l |
| point 3 | | | | | | |

| | pH | ORP | Conductivity | TDS | Nitrate | Ammonia |
|---|---|---|---|---|---|---|
| At | 8.18 | 500 mV | 2552 μS | 1877 | +/−40 ppm | 0 mg/l |
| point 4 | | | | | | |

A second test was performed on wastewater obtained from the same source as in test one. However, the second test was performed using four reactor tubes that each contained a MMO anode (i.e. no iron anodes were used). Readings were made at two points: (1) prior to being processed through the reactor tubes; and (2) after being processed through the four reactor tubes but prior to passing through the post processing filtration unit. The following tables list the readings for pH, ORP, conductivity, total dissolved solids (TDS), nitrate level, and ammonia level at these two points.

| | pH | ORP | Conductivity | TDS | Nitrate | Ammonia |
|---|---|---|---|---|---|---|
| At | 7.93 | 397 mV | 5287 μS | :4130 | +/−10 ppm | 9.98 mg/l |
| point 1 | | | | | | |

| | pH | ORP | Conductivity | TDS | Nitrate | Ammonia |
|---|---|---|---|---|---|---|
| At point 2 | 7.93 | 750 mV | 4895 μS | 3767 | +/−0 ppm | 0 mg/l |

As shown in the tables above, after the wastewater had been processed through the reactor tubes, the ammonia level of the wastewater had reached 0. Also, the ORP at these points was 750 mV indicating the correlation between ORP and ammonia levels in wastewater.

### Example 2

### Background

Chlorine dioxide is an important disinfectant for many applications for treating wastewater. It is known that chlorine dioxide can be generated electrochemically using chlorite, but other methods may be desirable. Previous tests with Origin Oil's EWS Aqua Q60 machine utilized either calcium hypochlorite or sodium hypochlorite injected by dosing pump or MX venturi into a feed stream of municipal tap water. These previous tests showed a small amount of chlorine dioxide generation and a large residual of unreacted hypochlorite. Chlorine generated through the electro-oxidation of chloride may also be used to generate chlorine dioxide. The following reactions represent these processes.

Cl⁻2+2H₂O→ClO₂+4H⁺5e⁻(1.599 V)

Cl₂+4H₂O→2ClO₂+8e⁻(1.540 V)

(See Bergmann, H., & Koparal, S. (2005). The formation of chlorine dioxide in the electrochemical treatment of drinking water for disinfection. Electrochimica acta, 50(25), 5218-5228, hereby incorporated in its entirety).

Method

Testing was performed to demonstrate the generation of chlorine dioxide from wastewater using the methods of this application. An EWS Aqua Q60 (Origin Oil, Los Angeles, Calif.) was modified to use only four of the available twelve SSE (Single Step Extractor) reactor tubes. The apparatus was equipped with 48″ cathode tubes. Flow through the apparatus was provided at roughly 50 gpm (gallons per minute) and a brine solution of approximately 120 g/l NaCl was injected by dosing pump at −27 ml/min. Power was supplied by a Dynapower power supply unit (Burlington, Vt.) at 17 V and 104 A (current density=267 A/m²). Under these conditions, a direct reading of chlorine dioxide measured 12-14 mg/l in the effluent stream.

The Q60 used in this test has an effective anode area of 0.389 m² and a maximum current density of 514 A/m2. The Dynapower power supply could not deliver the maximum current with the freshwater feed, but at 104 A it delivered a current density of 264 A/m². The test was run for approximately one working day. The Q60 was connected to a 500 gallon tank that was filled with tap water. The effluent from the Q60 was directed to drain. The MX venturi were removed from the Q60 and the dosing pump replaced and the reservoir filled with brine. The independent variables that were monitored included: water quality, feed flow rate, injection rate, and applied current. The dependent variable included chlorine dioxide in the effluent water and other standard water quality multiparameters. Measurements of chlorine dioxide were performed by direct measurement (Method 8345) on the Hach DR 890 colorimeter. Measurements of salt concentration were performed with the ISI Professional Plus multiparameter probe (Delta, Colo.).

Procedure

A 500 gallon tank was filled with tap water from the Los Angeles public water system. Initial salinity was measured at approximately 0.25 g/l. Salinity was then raised to 0.91 g/l by the addition of table salt (NaCl). The brine solution was injected at the pump inlet rather than pre-mixed into the feed water. Effluent was directed to the drain to avoid introducing chlorine products back into the feed. Maximum flow was estimated at 50 gpm. The dosing pump reservoir was filled with a salt solution of approximately 120 g/l (as measured by ISI Professional Plus multiparameter probe). The dosing pump, set at maximum, delivers ˜27 ml per minute. The Dynapower power supply was set at the maximum of 18V and 200 A. System resistance limited applied current to 104 A. The system was allowed to run for longer than 5 minutes before sampling. Measurements of chlorine dioxide were performed by direct measurement (Method 8345) on the Hach DR 890 colorimeter by taking 10 ml samples directly from the effluent stream. The colorimeter was calibrated with de-ionized water used as the blank. Measurement of chlorine dioxide in the influent tap water was also carried out.

Results and Discussion

The chlorine dioxide level of the influent tap water was measured at 0.0 mg/l. The chlorine dioxide levels of the effluent stream were measured at 12.3 mg/l and 14.2 mg/l by direct measurement in the effluent stream.

The Hach DR 890 colorimeter uses a colorimetric method to determine the level of chlorine dioxide in a sample. The instrument has a detection range of 0.0 to 50.0+/−0.3 mg/l ClO₂ with a lower detection limit of 7.3 mg/l. According to Hach technical support, chlorine gas is not a known interference for this colorimetric method. While additional measurement of chlorine dioxide levels may be desirable, the reactivity of chlorine dioxide must be taken into account. Any third-party confirmatory testing is not likely to be accurate unless it can be performed on-site as the samples are collected because of the reactivity of chlorine dioxide. In-house titration methods may be considered for further testing.

Both the known chemistry and the current analysis strongly support the conclusion that chlorine dioxide was electrochemically produced directly into the treated water stream at mg/l concentrations using only NaCl as a reagent. Furthermore, the proprietary anodes comprise noble metal anodes that have a long life and are not subject to decay through anodic donation. In the test the method produced chlorine dioxide at about 12-14 mg/l in influent wastewater inputted at about 50 gpm with an additional brine solution of approximately 120 g/l NaCl that was injected by dosing pump at approximately 27 ml/min. The process is scalable and by adding additional reactor tubes flow rates can be increased. The system has the capacity to scale up flow to 250 gpm or more. The system is easy to use and only requires the addition of plain salt (sodium chloride) and water to the attached dosing pump. There is not a major increase in the salinity of the effluent water. The power required is under 2 kW/h and within the range of a portable generator.

The system can incorporate filtration of the influent water and/or the effluent water to remove any organics. Additionally, to treat water for re-use in oil wells for H₂S handling, the test system can be coupled with an OriginOil P1000 platform to ensure removal of organics. The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed:

1. A system for treating wastewater comprising:
a series of interconnected reactor tubes, each reactor tube comprising an outer cathode and an inner anode, the inner anode being positioned centrally within the outer cathode such that a spacing exists between an outer surface of the inner anode and an inner surface of the outer cathode;
a pump connected to an input the of reactor tubes, the pump receiving influent wastewater and pumping influent wastewater into and through the series of reactor tubes such that the wastewater flows between the inner anodes and the outer cathodes; and
a power supply for supplying a voltage differential across the inner anodes and the outer cathodes to generate chlorine based elements from chloride salts within the wastewater, wherein the chlorine based elements treat the wastewater.

2. The system of claim 1, further comprising a feedback path to divert a portion of the wastewater with chlorine based elements back to an input of the pump such that the chlorine based elements are mixed with influent wastewater to increase the level of chlorine based elements available in the influent wastewater.

3. The system of claim 2, further comprising:
an injector connected to an input of the pump, the injector configured to add chloride salts to the influent wastewater.

4. The system of claim 3, further comprising:
a monitor configured to determine the chloride salt concentration of the influent wastewater.

5. The system of claim 4, wherein the monitor is further configured to activate the injector to add chloride salts to the influent wastewater based on the chloride salt concentration.

6. The system of claim 3, further comprising an oxidative reduction potential meter configured to measure the oxidative reduction potential of the treated wastewater, the meter configured to output a signal for controlling one or more of:
an amount of chloride salts that are added to the influent wastewater;
a rate at which the pump pumps wastewater through the reactor tubes;
a voltage level applied by the power supply; or
an amount of wastewater that is diverted back through the feedback path.

7. The system of claim 1, wherein the spacing between the outer surface of the inner anode and the inner surface of the outer cathode is between about 1 mm to about 9 mm.

8. The system of claim 1, wherein the inner anode comprises a non-donating conductive material.

9. The system of claim 8, wherein the non-donating conductive material further comprises platinum, ruthenium, rhodium, palladium, osmium, iridium, or combinations thereof.

10. The system of claim 8, wherein the non-donating conductive material further comprises titanium, carbon, conductive plastic, or combinations thereof.

11. The system of claim 1, wherein the pump comprises an impeller pump configured to generate micron bubbles within the wastewater due to cavitation.

12. The system of claim 1, wherein the chlorine based elements are hypochlorite.

13. The system of claim 2, further comprising:
a mixing chamber positioned after the pump and before the reactor tubes, wherein the chlorine based elements supplied through the feedback path are mixed with the influent wastewater in the mixing chamber.

14. The system of claim 1, wherein the outer cathode comprises a non-donating conductive material.

15. The system of claim 14, wherein the non-donating conductive material further comprises platinum, ruthenium, rhodium, palladium, osmium, iridium, titanium, carbon, conductive plastic, or combinations thereof.

16. The system of claim 1, wherein the outer cathode comprises a plurality of apertures.

17. A system for treating wastewater comprising:
an array of reactor tubes, each reactor tube comprising an outer cathode and an inner anode, the inner anode being positioned centrally within the outer cathode such that a spacing exists between an outer surface of the inner anode and an inner surface of the outer cathode, the inner anode comprising a non-donating material;
a pump connected to an input of the array, the pump receiving influent wastewater and pumping influent wastewater into and through the series of reactor tubes such that the wastewater flows between the inner anode and the outer cathode;
an injector connected to an input of the pump, the injector configured to add chloride salts to the influent wastewater;
a power supply for supplying a voltage differential across the inner anodes and outer cathodes to generate chlorine based elements from chloride salts within the wastewater, wherein the chlorine based elements treat the wastewater;
a feedback path to divert a portion of the wastewater with chlorine based elements back to an input of the pump such that the chlorine based elements are mixed with influent wastewater to increase the level of chlorine based elements available in the influent wastewater; and
an oxidative reduction potential meter configured to measure the oxidative reduction potential of the treated wastewater, the meter configured to output a signal for controlling one or more of an amount of chloride salts that are added to the influent wastewater, a rate at which the pump pumps wastewater through the reactor tubes, a voltage level applied by the power supply, or an amount of wastewater that is diverted back through the feedback path.

18. A method for treating wastewater comprising:
providing wastewater;
providing an array of interconnected reactor tubes, each reactor tube comprising an outer cathode and an inner anode being positioned centrally within the outer cathode such that a spacing exists between the outer surface of the anode and the inner surface of the cathode, at least one of the inner anodes comprising a non-donating conductive material;
injecting chloride salts into the wastewater;
pumping wastewater with chloride salts into and through the array such that the wastewater flows between the inner anodes and the outer cathodes;
applying a voltage differential to the anode and cathode of each reactor tube to generate chlorine based elements from the chloride salts, the chlorine based elements treating the wastewater to generate treated water; and
diverting a portion of the treated water to an input of the array such that chlorine based elements contained in the treated water are supplied into the wastewater that is pumped into the array.

19. The method of claim 18, wherein providing the wastewater further comprises pretreating the wastewater by gravity separation to remove a portion of hydrocarbons in the wastewater.

20. The method of claim 18, wherein the method further comprises filtration of the treated water.
